(19) United States
(12) Patent Application Publication
(10) Pub. No.: US 2026/0255170 A1
(43) Pub. Date: Aug. 27, 2026

(54) SCANNING FOR ROGUE DEVICES BY GROUPING WIRELESS ACCESS POINTS

(71) Applicant: Cisco Technology, Inc., San Jose, CA (US)

(72) Inventors: Chao FENG, Beijing (CN); Hao JIA, Dalian (CN); Rui WANG, Shanghai (CN); Fuli YU, Shanghai (CN); Hongbo XIA, Shanghai (CN)

(21) Appl. No.: 19/065,770

(22) Filed: Feb. 27, 2025

(51) Int. Cl. H04W 12/122; H04W 16/18; H04W 88/08

(52) U.S. Cl. CPC H04W 12/122; H04W 16/18; H04W 88/08

(57) ABSTRACT

Scanning techniques are described that assign APs with overlapping detection ranges into groups, and then ensuring those APs use different scanning patterns to scan the channels in a frequency band (e.g., the channels in the 2.4 GHz, 5 GHz, or 6 GHz frequency bands) to identify rogue devices. Because the APs use different scanning patterns (e.g., while a first AP scans for a rogue device in Channel 1 a second AP can scan for a rogue device in Channel 2), this means that two channels can be scanned in the regions where the detections ranges of the APs overlap (rather than the APs scanning the same channels at the same time). This results in the APs being able to identify rogue devices sooner, which provides the technical benefit of being able to mitigate the harmful effects of a rogue device sooner.

### TECHNICAL FIELD

Embodiments presented in this disclosure generally relate to detecting rogue devices.

### BACKGROUND

In the realm of wireless communications, the term “rogue” refers to any device operating within a frequency spectrum at a premise that is not under direct control of the owner or operator of the premise. This category encompasses unauthorized access points (APs), wireless routers, client devices, and ad-hoc networks. To identify and manage Wi-Fi-based rogue devices, wireless technology providers employ a range of detection techniques. These include conducting off-channel scans, utilizing dedicated monitoring APs, and integrating additional dedicated monitoring radios into APs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a system for scanning for rogue devices using APs in a scanning group, according to some embodiments disclosed herein.

FIG. 2 is a flowchart for scanning for rogue devices using APs in a scanning group, according to some embodiments disclosed herein.

FIG. 3 illustrates a scanning group with four APs, according to some embodiments disclosed herein.

FIG. 4 illustrates the probability of detecting a rogue AP in different scanning cycles, according to some embodiments disclosed herein.

FIG. 5 is a flowchart for selecting a size of a scanning group, according to some embodiments disclosed herein.

FIG. 6 depicts an example computing device configured to perform various aspects of the present disclosure, according to some embodiments disclosed herein.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes identifying a first access point (AP) and a second AP with overlapping detection ranges and scanning for rogue devices using the first and second APs where the first AP uses a channel scanning pattern that is different from a channel scanning pattern used by the second AP.

Another embodiment presented in this disclosure is a system that includes a first AP and a second AP with a detection range that overlaps a detection range of the first AP. Moreover, the first and second AP are configured to scan for rogue devices where the first AP uses a channel scanning pattern that is different from a channel scanning pattern used by the second AP.

Another embodiment presented in this disclosure is a networking device that includes one or more memories and one or more processor communicatively coupled to the one or more memories, where the one or more processors are configured to, individually or collectively, perform an operation that includes identifying a first AP and a second AP with overlapping detection ranges, and instructing the first and second APs to scan for rogue devices where the first AP uses a channel scanning pattern that is different from a channel scanning pattern used by the second AP.

### EXAMPLE EMBODIMENTS

The embodiments herein describe scanning techniques that assign APs with overlapping detection ranges into groups, and then ensuring those APs in a given group use different channel scanning patterns to scan the channels in a frequency band (e.g., the channels in the 2.4 GHz frequency band, the channels in the 5 GHz frequency band, the channels in the 6 GHz frequency band, etc.) to identify rogue devices. Because the APs use different scanning patterns (e.g., while a first AP scans for a rogue device in Channel 1 a second AP can scan for a rogue device in Channel 2), this means that two channels can be scanned in the regions where the detection ranges of the APs overlap (rather than the APs scanning the same channels at the same time). This results in the APs being able to identify rogue devices sooner, which provides the technical benefit of being able to mitigate the harmful effects of a rogue device quicker.

The embodiments herein can be applied to off-channel scanning, utilizing dedicated monitoring APs, and integrating additional dedicated monitoring radios into APs. These different techniques are described briefly to provide a general overview.

Off-channel scanning uses a time-slicing technique where the same radio services clients using a home channel but intermittently scans other channels looking for rogue devices. For example, the radio may move from a home channel to an off-channel for a period of 50 ms to look for a rogue device every 16 seconds, which means the AP only spends a small percentage of its time not serving clients on the home channel. Also, there may be a 10 ms channel change interval that occurs. Assuming a scan interval of 180 seconds, each 2.4 GHz FCC channel (111) is scanned at least once. For other regulatory domains, the AP may be off channel for a slightly higher percentage of time. In one embodiment, both the list of channels and scan interval can be adjusted in the radio resource management (RRM) configuration. This limits the performance impact to a maximum of 1.5% and, in one embodiment, intelligence is built into the algorithm to suspend the scan when high-priority QoS frames, such as voice, have to be delivered. However, other frequency bands (e.g., 5 GHz and 6 GHz) have more channels, which means an AP using off-channel scan takes even more time. But with the embodiments herein where APs are arranged in groups, rogue devices are likely to be found in fewer cycles making off-channel scanning more attractive. That is, a deployment may be able to avoid the extra hardware cost of having a dedicated scanning radio in an AP or have a dedicated monitor AP (which are discussed next).

Monitor mode scanning is performed by monitor-mode APs that use 100% of the radio time to scan each channel in each respective frequency band. This allows a greater speed of detection and enables more time to be spent on each individual channel. Monitor mode APs are also superior at detecting rogue clients as they have a more comprehensive view of the activity that occurs in each channel. The monitor mode AP can have different radios dedicated to each frequency band—e.g., a radio for scanning the channels in 2.4 GHz, a radio for scanning the channels in 5 GHz, and a radio for scanning the channels in 6 GHz. In addition, the detection time of rogue devices using monitor-mode APs can be decreased by using the embodiments herein, where monitor-mode APs with overlapping detection regions are assigned to groups and their scan patterns are synchronized.

A dedicated monitor radio synergistically harnesses the strengths of the aforementioned methods. Multi-radio access points have become prevalent in modern networking, ranging from dual-radio to tri-radio configurations and beyond. Leveraging surplus radio resources, an AP can simultaneously provide service to clients using (most) of its radios, while dedicating one (or more) radios to operate in a specialized monitor mode-akin to the functionality of a monitor-mode AP. This approach mirrors the efficiency and effectiveness of a monitor-mode AP but without the entire device being dedicated to monitoring for rogue APs.

When evaluating the three methods based on detection time, both the monitor mode access point and the dedicated monitor radio stand out for their significant advantages. This is largely due to their exclusive hardware, which enables constant channel scanning without interruption. Conversely, when cost is the primary consideration, the off-channel scanning approach is more economical. It operates on a part-time scanning basis and does not use additional hardware such as a separate radio or dedicated APs, thus keeping expenses to a minimum. Consequently, the off-channel scan is an optimal solution where cost is a priority. On the other hand, customers who prioritize performance over cost may opt for a dedicated monitor radio or a monitor-mode access point. However, with the embodiments herein, the detection time when using the off-channel scan can be reduced such that the gap between this strategy and using dedicated monitoring hardware is reduced, thus making off-channel scan more attractive.

Further, prior to Wi-Fi 6E, the limited number of channels—approximately 11 in the 2.4 GHz band and 23 in the 5 GHz band—made off-channel scanning a viable option. This method was favored for its acceptable performance without incurring the costs associated with dedicated monitor mode APs or radios. In this context, completing a scan of the 2.4 GHz channels can take around 200 seconds, and scanning every 5 GHz channel takes approximately 400 seconds, but this timing depends on the particular scan interval. These durations were considered tolerable for effective rogue device detection. However, the introduction of Wi-Fi 6E and the subsequent addition of 59 new channels in the 6 GHz band significantly altered this landscape. Adhering to the traditional off-channel scan method now takes an estimated 25 minutes to cycle through every channel (11 in 2.4 GHz, 23 in 5 GHz, and 59 in 6 GHz), which may be far too lengthy for timely rogue device detection. However, with the embodiments herein, detection times can be decreased so that using the off-channel scan is still a viable option with the increased number of wireless channels in the frequency bands.

Alternatively, the embodiments can be applied to monitoring systems that include dedicated monitor radios or monitor mode APs which can further improve their performance by reducing detection time so the negative effects of rogue devices can be mitigated sooner.

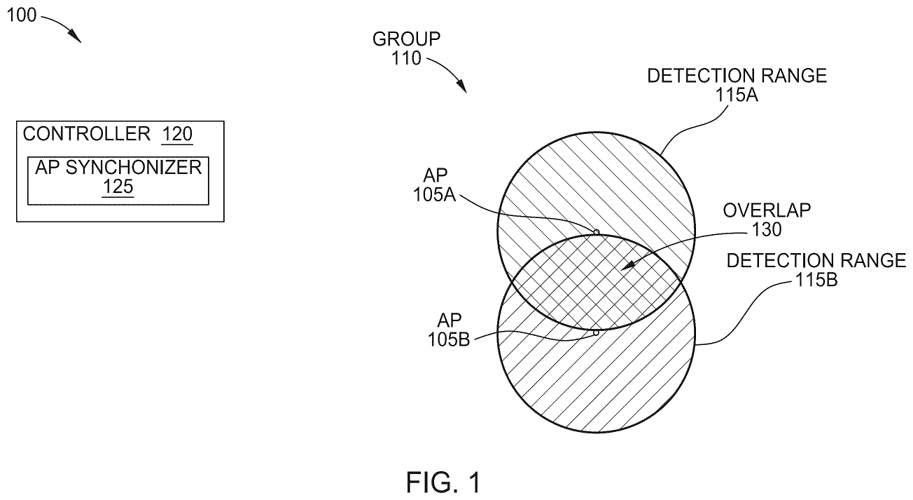

FIG. 1 is a system 100 for scanning for rogue devices using APs 105A and 105B in a scanning group 110, according to some embodiments disclosed herein. As shown, the APs 105A and 105B are arranged in an environment (e.g., a building, stadium, campus, etc.) and have detection ranges 115A and 115B that at least partially overlap 130 as shown in FIG. 1. In one embodiment, the detection range 115 is the area where an AP 105 can hear wireless devices—i.e., receive and decode a signal received from wireless devices. The detection range 115 can differ from a coverage area of the APs 105, which can be the area in which the APs 105 can transmit data to a wireless device. For example, the size of a coverage area can vary depending on the desired data speeds (e.g., a coverage area where the AP 105 can communicate at 10 MBs can be larger than a coverage area where the AP 105 can communicate at 20 MBs).

The system 100 includes a controller 120 that can communicate with the APs 105. For example, the controller 120 can be a separate device such as a wireless local area network (WLAN) controller (WLC) that manages the wireless network APs 105 that allow wireless devices to connect to the network.

In this example, the controller 120 includes an AP synchronizer 125 that assigns the APs 105 into the group 110 and controls or sets the channel scan patterns used by the APs 105 when searching for rogue devices. For example, the AP synchronizer 125 can assign the APs 105A and 105B into the same group 110 and then provide the scan patterns to each AP. As described in more detail below, the AP synchronizer 125 can ensure that at any given time, the APs 105 scan two different channels. Advantageously, this means that in the overlap 130, two different channels can be scanned for rogue devices in parallel. This can reduce the time it takes for the APs 105 to detect a rogue device (if a rogue device is located in an overlapping region between two APs in the same group).

Once the rogue device is detected, the controller 120 can perform any number of actions to mitigate the harm the rogue device can have on the network. For example, the controller 120 can instruct the APs 105 to change the channel they use to communicate with the associated client devices so they no longer use the same channel as the rogue device. In other embodiments, the controller 120 can use mitigation techniques to avoid the impact from the rogue device when using the same channel as the rogue device. In this manner, detecting rogue devices sooner using the embodiments herein can provide the technical advantage of improving the performance of the wireless network.

While FIG. 1 illustrates using a controller 120 to synchronize the scan patterns of the AP 105 so they scan different channels in parallel, in other embodiments this can be performed by one of the APs 105. For example, the APs can transmit AP-to-AP messages which can be used to assign the APs into groups and then synchronize their scan patterns so the APs in the same group use different scan patterns. Thus, the embodiments herein are not limited to using a controller as the networking device that organizes and synchronizes the APs.

Further, different APs in the same deployment may be assigned the same scanning patterns as the APs 105. For example, another AP (not shown in FIG. 1) may have a detection region that does not overlap with the detection ranges 115 of either AP 105A or AP 105B. This AP could be assigned to same scanning pattern as AP 105A or 105B. Or this AP could be assigned to a different scanning pattern as AP 105A or 105B. Either way, so longs as the APs 105A and 105B use different scanning sequences, there would be a performance gain.

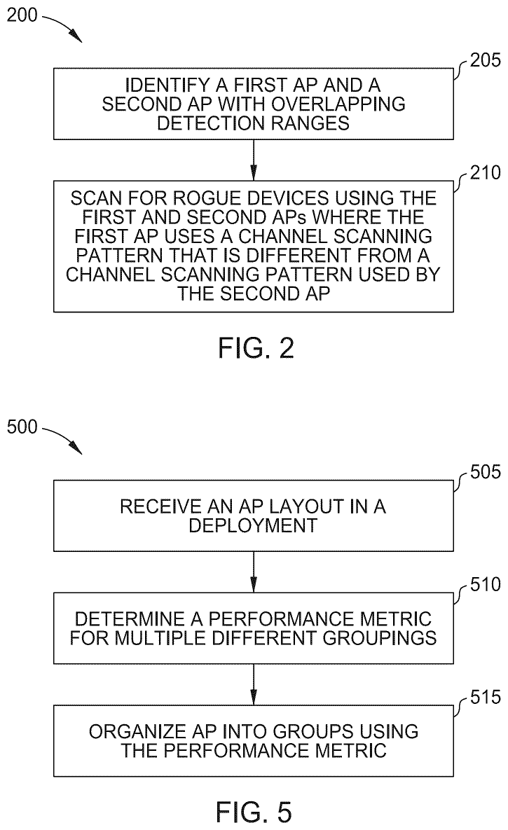

FIG. 2 is a flowchart of a method 200 for scanning for rogue devices using APs in a scanning group, according to some embodiments disclosed herein. At block 205, the controller identifies a first AP and a second AP with overlapping detection ranges. These APs can then be assigned to the same group.

The embodiments herein are not limited to any particular technique for determining whether two (or more) APs have overlapping detection ranges, and thus, can be placed in the same group. For example, this could be performed using a layout of an AP deployment and estimating their detection ranges. In other embodiment, APs may communicate using inter-AP messages, indicating they have overlapping detection ranges. In any case, the controller can assign APs with overlapping detection ranges into a group. These groups can include two, three, four, or more APs. In one embodiment, the APs in the same group may have at least one region of their detection ranges in common. However, this is not a requirement. For example, one group can include a first AP that has a detection range that overlaps with a detection range of a second AP and a third AP that has a detection range that overlaps with the detection range of the second AP, but the detection range of the third AP does not overlap the detection range of the first AP. In other words, these three APs would not share at least one region in common. Nonetheless, if these three APs are synchronized to each use a different scanning sequence, they would achieve a performance gain as discussed herein.

Moreover, while there may be additional performance gain if three (or more) APs with overlapping detection regions each use different scanning patterns, there can still be performance gain if only two of the three APs have different scanning patterns. That is, if two of the APs have the same scanning pattern but one AP has a different scanning patterns, these APs can detect rogue devices faster relative to a system where the APs each use the same scanning pattern.

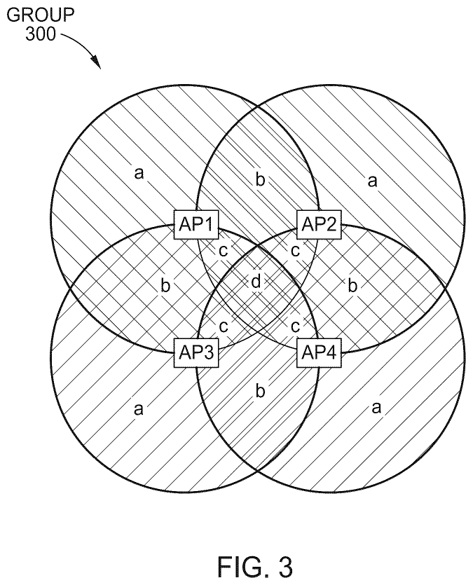

As examples, FIG. 1 illustrates a group 110 with two APs, while FIG. 3 illustrates a scanning group 300 with four APs-APs 1-4. In FIG. 3, the letters a, b, c, and d label different areas of the detection ranges of the APs 1-4. The regions labeled “a” represent regions in the detection ranges where there is no overlap (only one of the APs in the group 300 include the region in its detection range), the regions labeled “b” represent regions in the detection ranges where there is overlap between two of the APs in the group 300, the regions labeled “c” represent regions in the detection ranges where there is overlap between three of the APs in the group 300, and the region labeled “d” represents a region in the detection ranges where there is overlap between the four APs in the group 300.

Returning to method 200, at block 210 the first and second APs scan for rogue devices where the first AP uses a channel scanning pattern that is different from a channel scanning pattern used by the second AP. For example, the first and second APs can be synchronized such that, at any given time, the first AP scans for a rogue device on a different channel than the second AP. For example, assuming there are 60 channels, the first AP can first scan Channel 1 while the second AP scans Channel 31. In the next cycle, the first AP can scan Channel 2 while the second AP scans Channel 32. In the next cycle, the first AP scans Channel 3 while the second AP scans Channel 33, and so forth until the first and second AP both scan the 60 channels.

In another example, again assuming there are 60 channels, the first AP can first scan Channel 1 while the second AP scans Channel 2. In the next cycle, the first AP can scan Channel 2 while the second AP scans Channel 3. In the next cycle, the first AP scans Channel 3 while the second AP scans Channel 4, and so forth until the first and second AP both scan the 60 channels. Thus, the embodiments are not limited to any particular channel separation between the APs as they scan. The advantages described herein can be realized so long as the APs scan different channels in parallel (e.g., in the same scan cycle).

Moreover, a “scan cycle” can vary depending on the type of scanning technique being used. For example, if performing off-channel scanning, a scan cycle includes a period of time which a radio in the AP services a client using a home channel, as well as a period of time where the radio stops serving the client and moves to a different channel to scan for a rogue device. However, in scanning techniques that use a dedicated radio or AP, the scan cycle can be the time used by the radio/AP to scan a particular channel to look for a rogue device before then moving to the next channel.

Because the first and second APs scan different channels in the same cycle, this means the overlapping region of their detection ranges is being scanned for a rogue device on two channels in parallel. As discussed in more detail below, this can decrease the amount of time used to detect a rogue device.

Referring again to FIG. 3, the four APs can scan different channels during each scan cycle. For example, during a first scan cycle, AP1 scans the first channel, AP2 scans the 16^{th} channel, AP3 scans the 31^{st} channel, and AP4 scans the 46th channel (assuming 60 channels). During a second scan cycle, AP1 scans the 2^{nd} channel, AP2 scans the 17^{th} channel, AP3 scans the 32^{nd} channel, and AP4 scans the 47^{th} channel. During a third scan cycle, AP1 scans the 3^{rd} channel, AP2 scans the 18^{th} channel, AP3 scans the 33^{rd} channel, and AP4 scans the 48^{th} channel, and so forth.

Because the four APs scan different channels in the same cycle, this means the overlapping regions labeled “b” are being scanned for a rogue device on two channels in parallel, the overlapping regions labeled “c” are being scanned for a rogue device on three channels in parallel, and the overlapping region labeled “d” is being scanned for a rogue device on four channels in parallel. As discussed next, this can decrease the amount of time used to detect a rogue device.

The detection probability for detecting a rogue device can be expressed as:

$${P}_{N} = {P}_{location \_ a} \times {P}_{channel \_ scanned \_ a} + {P}_{location \_ b} \times {P}_{channel \_ scanned \_ b} + {P}_{location \_ c} \times {P}_{channel \_ scanned \_ c} + {P}_{location \_ d} \times {P}_{channel \_ scanned \_ d} \qquad ( 1 )$$

where P_{N} is the probability of detecting the rogue AP within N cycles, P_{location_x} is the probability that the rogue AP is located within a specific area (a, b, c, or d), and P_{channel_scanned_x} is the probability that the rogue AP's channel is among those being scanned in that area within N cycle. Further, assuming the APs 1-4 are spaced apart by a distance of radius r of the detection ranges and S0 is the area of the detection ranges with the radius r, the areas of the regions labeled a, b, c, and d are:

$$Area of a : {S}_{a} = 0.38 * S 0$$

$$Area of b : {S}_{b} = 0.2 * S 0$$

$$Area of c : {S}_{c} = 0.04 * S 0$$

$$Area of d : {S}_{d} = 0.1 * S 0$$

When the scan cycle N is between 0 and 15, there will be no overlapping channels that has been scanned (assuming the scanning pattern discussed previously), even in the overlapping areas b, c, and d. The probability in Equation 1 can then be expressed as:

$${P}_{4 Group} = {P}_{location \_ a} * {P}_{channel \_ scanned \_ a} + {P}_{location \_ b} * {P}_{channel \_ scanned \_ b} + {P}_{location \_ c} * {P}_{channel \_ scanned \_ c} + {P}_{location \_ d} * {P}_{channel \_ scanned \_ d} \qquad ( 2 )$$

$$( 3 )$$

$$= 4 * \frac{{S}_{a}}{4 * {S}_{a} + 4 * {S}_{a} + 4 * {S}_{c} + {S}_{d}} ⋆ \frac{N}{60} + 4 * \frac{{S}_{b}}{4 * {S}_{a} + 4 * {S}_{a} + 4 * {S}_{c} + {S}_{d}} ⋆ \frac{2 N}{60} + 4 * \frac{{S}_{c}}{4 * {S}_{a} + 4 * {S}_{a} + 4 * {S}_{c} + {S}_{d}} ⋆ \frac{3 N}{60} + \frac{{S}_{d}}{4 * {S}_{a} + 4 * {S}_{a} + 4 * {S}_{c} + {S}_{d}} ⋆ \frac{4 N}{60}$$

$$= \frac{N}{38.4} \qquad ( 4 )$$

When the scan cycle N is between 15 and 30, there will be no overlapping channels that have been scanned in area a and part of area b, but in area c and d and part of b, scanned channels start to overlap with each other, and in area d, each of the 60 channels have been scanned. For areas labeled with a, there is no overlapping channel has been scanned, so the

$${P}_{channel \_ scanned \_ a} = \frac{N}{60} .$$

For areas labeled with b, there are two conditions: (i) for the overlapping areas between AP1 and AP2 and between AP3 and AP4, there are overlapping channels, so the

$${P}_{channel \_ scanned \_ b} = \frac{N + 15}{60} ,$$

but (ii) for the overlapping areas between AP2 and AP4 and between AP1 and AP3, there is no overlapping channels, so the

$${P}_{channel \_ scanned \_ b} = \frac{N}{60} .$$

For areas labelled c, there are overlapping channels being scanned, so the

$${P}_{channel \_ scanned \_ b} = \frac{N + 30}{60} .$$

For the area labelled d, all 60 channels have been scanned, so

$${P}_{channel \_ scanned \_ b} = \frac{60}{60} .$$

The probability in Equation 2 for this time frame can then be expressed as:

$$( 5 )$$

$$= 4 * \frac{{S}_{a}}{4 * {S}_{a} + 4 * {S}_{a} + 4 * {S}_{c} + {S}_{d}} ⋆ \frac{N}{60} + 2 * \frac{{S}_{b}}{4 * {S}_{a} + 4 * {S}_{a} + 4 * {S}_{c} + {S}_{d}} ⋆ \frac{2 N}{60} + 2 * \frac{{S}_{b}}{4 * {S}_{a} + 4 * {S}_{a} + 4 * {S}_{c} + {S}_{d}} ⋆ \frac{N + 15}{60} + 4 * \frac{{S}_{c}}{4 * {S}_{a} + 4 * {S}_{a} + 4 * {S}_{c} + {S}_{d}} ⋆ \frac{N + 30}{60} + \frac{{S}_{d}}{4 * {S}_{a} + 4 * {S}_{a} + 4 * {S}_{c} + {S}_{d}} ⋆ \frac{60}{60}$$

$$= \frac{2.88 N + 16.8}{154.8} \qquad ( 6 )$$

When the scan cycle N is between 30 and 45, no overlapping channels have been scanned in area a, but in area b scanned channels start to overlap with each other, and in areas c and d and part of area b, each of the 60 channels has been scanned. For areas labeled with a, there is no overlapping channel that has been scanned, so the

$${P}_{channel \_ scanned \_ a} = \frac{N}{60} .$$

For areas labeled with b, there are two conditions: (i) for the overlapping area between AP1 and AP2 and between AP3 and AP4, there are overlapping channels, so the

$${P}_{channel \_ scanned \_ b} = \frac{N + 15}{60} ,$$

but (ii) for the overlapping area between AP2 and AP4 and between AP1 and AP3, each of the 60 channels have been scanned, so the

$${P}_{channel \_ scanned \_ b} = \frac{60}{60} .$$

For areas labelled c and d, each of the 60 channels have been scanned, so the

$${P}_{channel \_ scanned \_ b} = \frac{60}{60} .$$

The probability in Equation 2 for this time frame can then be expressed as:

$$( 7 )$$

$$= 4 * \frac{{S}_{a}}{4 * {S}_{a} + 4 * {S}_{a} + 4 * {S}_{c} + {S}_{d}} ⋆ \frac{N}{60} + 2 * \frac{{S}_{b}}{4 * {S}_{a} + 4 * {S}_{a} + 4 * {S}_{c} + {S}_{d}} ⋆ \frac{2 N}{60} + 2 * \frac{{S}_{b}}{4 * {S}_{a} + 4 * {S}_{a} + 4 * {S}_{c} + {S}_{d}} ⋆ \frac{N + 15}{60} + 4 * \frac{{S}_{c}}{4 * {S}_{a} + 4 * {S}_{a} + 4 * {S}_{c} + {S}_{d}} ⋆ \frac{N + 30}{60} + \frac{{S}_{d}}{4 * {S}_{a} + 4 * {S}_{a} + 4 * {S}_{c} + {S}_{d}} ⋆ \frac{60}{60}$$

$$= \frac{2.88 N + 16.8}{154.8} \qquad ( 8 )$$

When the scan cycle N is between 45 and 60, there are no overlapping channels that have been scanned in area a, but in the areas labelled b and c and d, each of the 60 channels have been scanned. For areas labeled with a, since no overlapping channel have been scanned, the

$${P}_{channel \_ scanned \_ a} = \frac{N}{60} .$$

For areas labeled b, c, and d, each of the 60 channels has been scanned, so the

$${P}_{channel \_ scanned \_ b} = \frac{60}{60} .$$

The probability in Equation 2 for this time frame can then be expressed as:

$$( 9 )$$

$$= 4 * \frac{{S}_{a}}{4 * {S}_{a} + 4 * {S}_{a} + 4 * {S}_{c} + {S}_{d}} ⋆ \frac{N}{60} + 4 * \frac{{S}_{b}}{4 * {S}_{a} + 4 * {S}_{a} + 4 * {S}_{c} + {S}_{d}} ⋆ \frac{60}{60} + 4 * \frac{{S}_{c}}{4 * {S}_{a} + 4 * {S}_{a} + 4 * {S}_{c} + {S}_{d}} ⋆ \frac{60}{60} + \frac{{S}_{d}}{4 * {S}_{a} + 4 * {S}_{a} + 4 * {S}_{c} + {S}_{d}} ⋆ \frac{60}{60}$$

$$= \frac{1.52 N + 63.6}{154.8} \qquad ( 10 )$$

The probability of detecting the rogue AP within N cycles (P_{4Group}) can be expressed in these time frames as:

$$\frac{N}{38.4} ( 0 <= N <= 15 )$$

$$\frac{2.88 N + 16.8}{154.8} ( 15 < N <= 30$$

$$\frac{2.88 N + 16.8}{154.8} ( 30 < N <= 45 )$$

$$\frac{1.52 N + 63.6}{154.8} ( 45 < N <= 60 )$$

This process can be repeated to determine the probability of detecting the rogue AP within N cycles for different sized groups—e.g., a group with two APs, a group with three APs, etc.

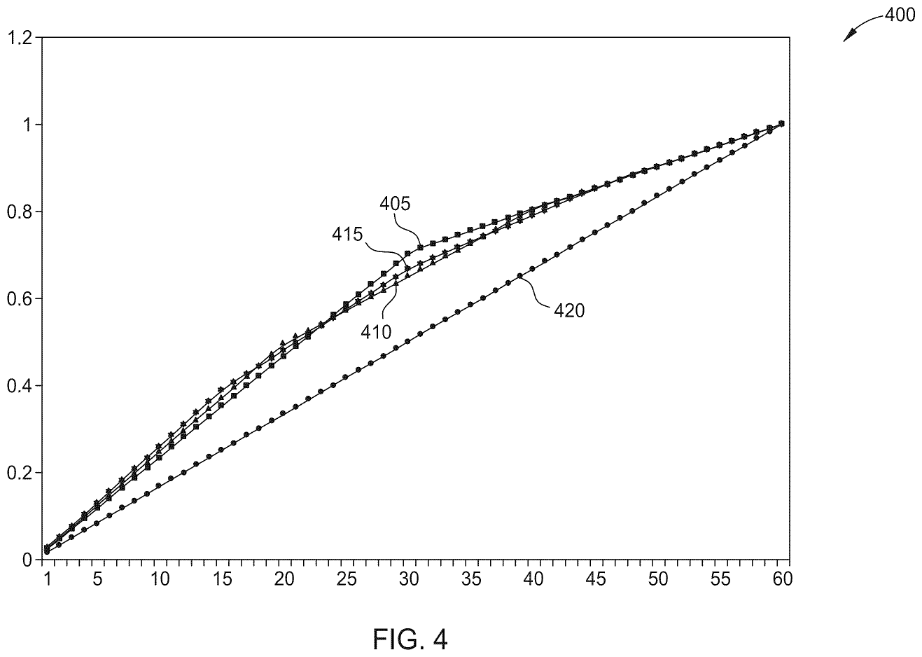

FIG. 4 is a chart 400 illustrating the probability of detecting a rogue AP in different scanning cycles, according to some embodiments disclosed herein. Specifically, the chart illustrates the detection probability for a group with two APs (plot 405), the detection probability for a group with three APs (plot 410), the detection probability for a group with four APs (plot 415), and the detection probability for a single AP where grouping is not used (plot 420).

The X-axis lists the scan cycle number while the Y-axis indicates the probability that the different scanning techniques will detect the rogue device during the scan cycle. As shown, the plots 405-415 indicate that grouping the APs and using different scan patterns drastically increases the probability of detecting a rogue device relative to plot 420 where APs are not placed in groups and instead scan for rogue devices independently of the other APs in the deployment.

FIG. 5 is a flowchart of a method 500 for selecting a size of a scanning group, according to some embodiments disclosed herein. As discussed above (and shown in FIG. 4), different sized groups can change the detection probability (which can change the size of the overlapping regions). Thus, for some deployments, having different sized groups can provide better results (i.e., the likelihood of detecting a rogue device in the earlier scans is increased). The method 500 describes techniques for determining the group assignments for the APs.

At block 505, the controller can receive an AP layout in a deployment. For example, method 500 assumes that a system administrator has already determined a layout of the APs.

At block 510, the controller determines a performance metric for multiple different group sizes. For example, the controller may try many different groupings such as assigning APs to groups of two, or groups of three, or groups of four and determining a performance metric with each of those different group assignments. In another example, the controller may use distance between the APs to determine their groupings. For example, the controller may determine the density of APs in different areas of the deployment, where APs in higher density areas are assigned to larger groups and APs in lower density areas are assigned to smaller groups. In any case, at block 510 the controller can try a variety of different assignment strategies to assign the APs to different groups, and then determine a performance metric for each of those assignments.

One example of a performance metric that can be used to compare the different group assignments is the average number of scan cycles required to locate a rogue device, which should be the expected number of scan cycles needed to detect a rogue device. To determine the average number of scans, note that the cumulative probability P_{N} in Equation 1 is the sum of the probabilities of finding the rogue AP in each cycle up to cycle N:

$${P}_{N} = {P}_{0 - 1} + {P}_{1 - 2} + … + {P}_{( N - 1 ) - N} \qquad ( 11 )$$

Where P₀₋₁ represents the probability of finding the rogue AP in the first cycle, P₁₋₂ represents the probability of finding the rogue AP in the second cycle, and P_{(N-1)-N} represents the probability of finding the rogue AP in the Nth cycle. It follows that the probability P_{(N-1)-N} can be expressed as:

$${P}_{( N - 1 ) - N} = {P}_{N} - {P}_{N - 1} \qquad ( 12 )$$

The average number of scan cycles required to locate a rogue AP can be expressed as:

$$E ( N ) = {\sum }_{N = 1}^{60} {P}_{( N - 1 ) - N} * N \qquad ( 13 )$$

Using the Equation 13, the controller can calculate the average scan cycle for different assignments of the groups as shown in Table 1.

TABLE 1

| # of APs in each | |
|---|---|
| Group | E(N) |
| 2 | 24.397 avg. scans |
| 3 | 24.556 avg. scans |
| 4 | 24.395 avg. scans |
| Legacy (No | 30.5 avg. scans |
| Grouping) | |

In addition to comparing the different group sizes to each other, Table 1 also illustrates that each of the group strategies is a 20% improvement over a scanning strategy that does not assign to the APs to groups and synchronize their scan patterns.

However, the average scan cycle is just one suitable performance metric that can be used to compare different groups of APs in a deployment. Other suitable performance metrics (or combinations of performance metrics) can be used.

At block 515, the controller organizes the APs into groups using the performance metric. For example, since grouping the APs in groups of four results in the lowest average scan in the particular deployment shown in FIG. 3, the controller may select this grouping strategy to assign the APs into groups (e.g., an AP is grouped with its three closest neighboring APs). However, when the APs are spaced differently than shown in FIG. 3, other grouping strategies (e.g., groups of 2 or 3) may result in better performance metrics (e.g., lower average scan cycles) than groups of four APs.

Once assigned into groups, as discussed above, the controller can synchronize the scan patterns in the groups so the APs scan different channels.

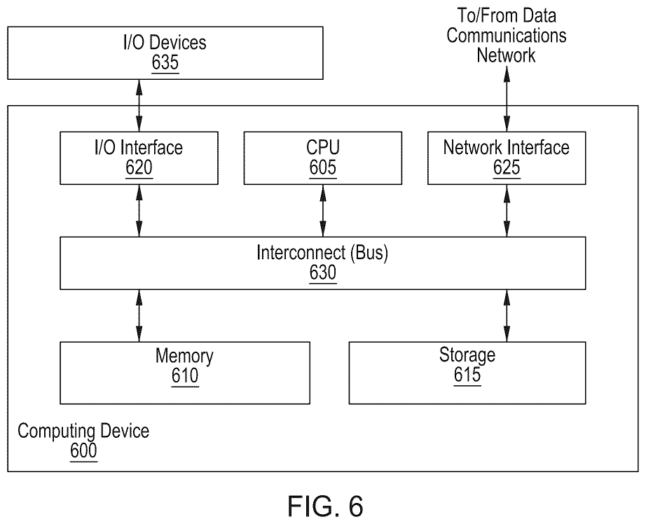

FIG. 6 depicts an example computing device 600 configured to perform various aspects of the present disclosure, according to some embodiments disclosed herein. Although depicted as a physical device, in embodiments, the computing device 600 may be implemented using virtual device(s), and/or across a number of devices (e.g., in a cloud environment). In one embodiment, the computing device 600 corresponds to a network device (e.g., a computing system), such as the AP 105 of FIGS. 1 and 3 or the controller 120.

As illustrated, the computing device 600 includes a CPU 605, memory 610, storage 615, a network interface 625, and one or more input/output (I/O) interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

If the computing device 600 is a controller, the memory 610 can include the AP synchronizer 125 discussed in FIG. 1 for assigning the APs to groups (based on overlapping detection ranges) and synchronize the APs to use different scan patterns. If the computing device is an AP 105 in FIG. 1, the memory 710 can store the scan patterns assigned by the controller. The APs 105 can also include detection logic for identifying rogue devices based on scanning the channels in one or more frequency bands. Although as residing in memory 610, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
identifying a first access point (AP) and a second AP with overlapping detection ranges; and
scanning for rogue devices using the first and second APs where the first AP uses a channel scanning pattern that is different from a channel scanning pattern used by the second AP.

2. The method of claim 1, wherein the channel scanning patterns used by the first and second APs ensure that the first and second APs scan, in parallel, different channels in a region where the detection ranges of the first and second APs overlap.

3. The method of claim 1, further comprising:
identifying a third AP with a detection range that overlaps with the detection ranges of both the first and second AP; and
scanning for rogue devices using the third AP where the third AP uses a channel scanning pattern that is different from the channel scanning patterns used by the first and second APs.

4. The method of claim 3, wherein the channel scanning patterns used by the first, second, and third APs ensure that the first, second, and third APs scan, in parallel, different channels in a region where the detection ranges of the first, second, and third APs overlap.

5. The method of claim 1, further comprising:
identifying a third AP with a detection range that overlaps with the detection range of the second AP but not the first AP; and
scanning for rogue devices using the third AP where the third AP uses a channel scanning pattern that is different from the channel scanning patterns used by the first and second APs.

6. The method of claim 1, wherein scanning for rogue devices comprises:
performing off-channel scanning where the first and second APs repeatedly switch a respective radio to a home channel for a first period of time and then switch the radio to a different channel to search for a rogue device for a second period of time.

7. The method of claim 1, wherein the first and second APs are monitor mode APs.

8. The method of claim 1, wherein scanning for rogue devices is performed using dedicated monitor radios in the first and second APs, wherein the first and second APs comprises other radios to service connected clients while the dedicated monitor radios scan for rogue devices.

9. A system comprising:
a first access point (AP); and
a second AP with a detection range that overlaps a detection range of the first AP,
wherein the first and second AP are configured to scan for rogue devices where the first AP uses a channel scanning pattern that is different from a channel scanning pattern used by the second AP.

10. The system of claim 9, wherein the channel scanning patterns used by the first and second APs ensure that the first and second APs scan, in parallel, different channels in a region where the detection ranges of the first and second APs overlap.

11. The system of claim 9, further comprising:
a third AP with a detection range that overlaps with the detection ranges of both the first and second AP,
wherein the third AP is configured to scan for rogue devices using a channel scanning pattern that is different from the channel scanning patterns used by the first and second APs.

12. The system of claim 11, wherein the channel scanning patterns used by the first, second, and third APs ensure that the first, second, and third APs scan, in parallel, different channels in a region where the detection ranges of the first, second, and third APs overlap.

13. The system of claim 9, further comprising:
a third AP with a detection range that overlaps with the detection range of the second AP but not the first AP; and
wherein the third AP is configured to scan for rogue devices using a channel scanning pattern that is different from the channel scanning patterns used by the first and second APs.

14. The system of claim 8, wherein scanning for rogue devices is performed using dedicated monitor radios in the first and second APs, wherein the first and second APs comprises other radios to service connected clients while the dedicated monitor radios scan for rogue devices.

15. A networking device comprising:
one or more memories; and
one or more processor communicatively coupled to the one or more memories, wherein the one or more processors are configured to, individually or collectively, perform an operation comprising:
identifying a first access point (AP) and a second AP with overlapping detection ranges; and
instructing the first and second APs to scan for rogue devices where the first AP uses a channel scanning pattern that is different from a channel scanning pattern used by the second AP.

16. The networking device of claim 15, wherein the channel scanning patterns used by the first and second APs ensure that the first and second APs scan, in parallel, different channels in a region where the detection ranges of the first and second APs overlap.

17. The networking device of claim 15, wherein the operation further comprises:
identifying a third AP with a detection range that overlaps with the detection ranges of both the first and second AP; and
instructing the third AP to scan for rogue devices using a channel scanning pattern that is different from the channel scanning patterns used by the first and second APs,
wherein the channel scanning patterns used by the first, second, and third APs ensure that the first, second, and third APs scan, in parallel, different channels in a region where the detection ranges of the first, second, and third APs overlap.

18. The networking device of claim 15, wherein scanning for rogue devices comprises:
performing off-channel scanning where the first and second APs repeatedly switch a respective radio to a home channel for a first period of time and then switch the radio to a different channel to search for a rogue device for a second period of time.

19. The networking device of claim 15, wherein the operation further comprises:
identifying a third AP with a detection range that overlaps with the detection range of the second AP but not the first AP; and
scanning for rogue devices using the third AP where the third AP uses a channel scanning pattern that is different from the channel scanning patterns used by the first and second APs.

20. The networking device of claim 15, wherein scanning for rogue devices is performed using dedicated monitor radios in the first and second APs, wherein the first and second APs comprises other radios to service connected clients while the dedicated monitor radios scan for rogue devices.
